(19) United States
(12) Patent Application Publication
(10) Pub. No.: US 2009/0228412 A1
(43) Pub. Date: Sep. 10, 2009

(54) RE-LEARNING METHOD FOR SUPPORT VECTOR MACHINE

(75) Inventors: Kazunori MATSUMOTO, Fujimino-shi (JP); Dung Duc NGUYEN, Fujimino-shi (JP); Yasuhiro TAKISHIMA, Fujimino-shi, (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KDDI CORPORATION, Tokyo (JP)

(21) Appl. No.: 12/400,083

(22) Filed: Mar. 9, 2009

(30) Foreign Application Priority Data
Mar. 7, 2008 (JP) 2008-057921

(51) Int. Cl. G06F 15/18

(52) U.S. Cl. 706/12; 702/181; 382/199

(57) ABSTRACT

A re-learning method includes: a step of learning an SVM by using a set of training samples for initial learning which have known labels; a step of perturbation-processing the training samples for initial learning; a step of using the perturbation-processed sample as a training sample for addition; and a step of re-learning the learned SVM by using the training sample for initial learning and the training sample for addition. For the training samples for initial learning to be perturbation-processed, a training sample obtained by removing a training sample for initial learning corresponding to a non-support vector, a training sample corresponding to a support vector existing on a soft margin hyperplane, etc., may be used.

### BACKGROUND OF THE INVENTION

1. Field of the Invention

The present invention relates to a re-learning method for a support vector machine, and particularly, relates to a re-learning method for a support vector machine capable of implementing the improvement of a classification performance and the reduction of a computation amount.

2. Description of the Related Art

For systems that search or manage video archives, a function of a shot boundary detection for detecting a shot boundary occurring during an editing task from an existing video file is essential. Therefore, a support vector machine (hereinafter, referred to as SVM) is applied so as to realize a high-performance shot boundary detector.

In Patent Document 1 described below, a feature extraction method for detecting a shot boundary is disclosed. As clearly specified in Patent Document 1, the obtained feature amount is classified by using a pattern recognition device such as the SVM. The precondition of the SVM is that training samples previously prepared are used for learning so as to construct an SVM for classification. In Patent Document 2, there is disclosed an invention relating to a data classifier in which a support vector machine performs a data classification based on a learning result obtained by using an active learning method.

Moreover, there is also a related art called semi-supervised learning. In the semi-supervised learning, a learning machine constructed from a set of samples attached with known labels is used to extract a sample close to a label-imparted instance from among a set of unlabeled samples, and on the precondition that the extraction is almost successful, further learning (called “re-learning”) is performed, whereby it is intended to improve the performance of a classifier. An expansion technique of a case where this technology is applied to the SVM is described in Non-Patent Document 1.

Patent Document 1: Japanese Published Unexamined Patent Application No. 2007-142633

Patent Document 2: Japanese Published Unexamined Patent Application No. 2004-21590 Non-Patent Document 1: Operations Research Society of Japan, “Semi-Supervised Learning based on SVM,” Abstracts, the 2005 Fall Research Presentation Forum of Operations Research Society of Japan, Vol. 2005 (20050914), pp. 32-33

There is a possibility of improving the classification performance if the technologies described in Patent Document 1 and Non-Patent Document 1 are combined, i.e., if the technology of the semi-supervised learning is applied to the classifier (SVM) for shot detection. However, in the normal semi-supervised learning, there are many cases that the labels of samples to be added for re-learning are wrong because these are imparted by the classifier before the re-learning. There is a problem that when the samples including those wrongly attached with the labels are learned, the performance after re-learning is not sufficiently improved.

Moreover, in the technique presented by Non-Patent Document 1, there is a problem that the number of samples added is enormous and the re-learning becomes very difficult.

### SUMMARY OF THE INVENTION

An object of the present invention is to provide a re-learning method for a support vector machine, capable of achieving the accuracy improvement of an SVM and the reduction in a calculation amount by re-learning using a small number of high quality samples.

In order to achieve the object, a first feature of the present invention is that a re-learning method for a support vector machine comprises a step of learning an SVM by using a set of training samples for initial learning which have known labels, a step of perturbation-processing the training samples for initial learning, a step of using the perturbation-processed sample as a training sample for addition, and a step of re-learning the learned SVM by using the training sample for initial learning and the training sample for addition.

A second feature is that the training sample for initial learning to be perturbation-processed is a training sample obtained by removing the training sample for initial learning corresponding to a non-support vector.

A third feature is that the training sample for initial learning to be perturbation-processed is a training sample corresponding to a support vector existing on a soft margin hyperplane.

A fourth feature is that the training sample for initial learning to be perturbation-processed is a training sample corresponding to a support vector existing on a soft margin hyperplace having an inferior determination performance at the time of evaluating a conditional probability that a support vector on the soft margin hyperplane belongs to another class using a logistic function derived by using a maximum likelihood estimation.

In the perturbation learning according to the present invention, the training samples having a new feature amount are generated by making use of the fact that the position of the shot boundary does not change even if an image process such as luminance conversion is performed on video data. As such, the present invention differs greatly from the normal semi-supervised learning in that label imparting of the training sample to be newly added is precise, and thus, the effect of the re-learning is improved.

Moreover, even if the sample, which is apart from the existing boundary surface, is subjected to perturbation, it is highly likely not to affect, as anon-support vector, the position of the boundary surface. Thereby, the non-support vector is not subject to the perturbation, and in this way, accuracy improvement and reduction in a calculation amount can be achieved.

And, it is highly likely that the α=C support vector being near the classification boundary is an outlier. Consequently, when a new sample is added by perturbation, the effect is limited and a risk is greater. As such, when the target to be perturbed is limited to a support vector existing on a margin hyperplane, it becomes possible to achieve the accuracy improvement and the reduction in the calculation amount.

Furthermore, when there is a bias in the number of samples among classes such as shot boundary detection, the separation accuracy with other classes is not very good near the margin hyperplane. Thus, a logistic function derived by using a maximum likelihood estimation is used to evaluate a conditional probability in which a support vector on the soft margin hyperplane belongs to the other classes, and only those hyperplane support vectors having an inferior determination performance are targets to be perturbed. Therefore, the accuracy improvement and the reduction in the calculation amount can be achieved.

### BRIEF DESCRIPTION OF THE DRAWINGS

FIG. 1 is a flowchart showing a brief process procedure of a first embodiment of the present invention.

FIG. 2 is a flowchart showing a brief process procedure of a second embodiment of the present invention.

FIG. 3 is a flowchart showing a brief process procedure of a third embodiment of the present invention.

FIG. 4 is a graph of a logistic function indicating a conditional probability obtained from training data of an instantaneous cut detection.

FIG. 5 is a diagram describing a positional relationship on a kernel space between a hyperplane representing a soft margin and a support vector.

FIG. 6 is a diagram showing an example of an image quality conversion.

### DETAILED DESCRIPTION OF THE PREFERRED EMBODIMENTS

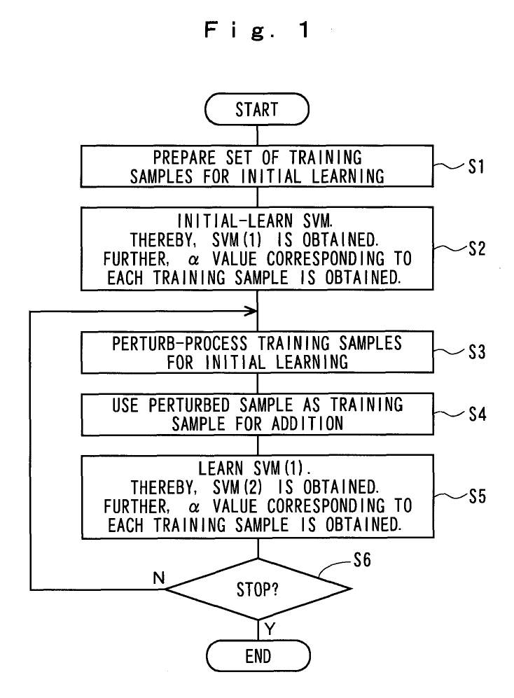

FIG. 1 is a flowchart showing a brief process procedure of a first embodiment of the present invention.

In this embodiment, luminance conversion and contrast conversion are performed on video data used for learning so as to change a value of a feature amount used for boundary detection (hereinafter, referred to as “perturbation”), whereby a new learning sample is generated.

First, at step S1, a set of training samples for initial learning is prepared. For the set of training samples for initial learning, data {x1, x2, x3, . . . , xm} having known class labels {y1, y2, y3, . . . , ym} is prepared. At step S2, the set of training samples for initial learning is used to perform initial learning (pilot learning) of SVM. Through this process, a parameter (α value) corresponding to the training sample for initial learning is obtained, as well as an initially learned SVM (1). The meaning of this parameter (α value) will be described later. At step S3, the training sample for initial learning is subjected to a perturbation process. The perturbation process will be described in detail later.

As a matter of course, the feature amount of the perturbation-processed training sample for initial learning (hereinafter, “new sample”) is different from a feature amount of the training sample for initial learning. However, the class label of the new sample carries over the class label of the training sample for initial learning. At step S4, the perturbed sample is set as a training sample to be added. At step S5, the training sample for initial learning and the training sample for addition are used to re-learn the SVM, thereby generating a re-learned SVM (2). At this time, a parameter (α value) corresponding to each training sample is obtained. At step S6, it is determined whether to stop the re-learning process. When the determination is negative, the process returns to step S3 to repeat the aforementioned process. When the process is repeated, further re-learned SVMs (3), (4), . . . , can be obtained. On the other hand, when the step S6 is positive, the re-learning process is stopped.

According to this embodiment, the training sample for addition carries over the class label of the training sample for initial learning. Thus, it is possible to further implement the accuracy improvement of the SVM and the reduction in calculation amount, as compared to the conventional re-learning by using samples without the class label.

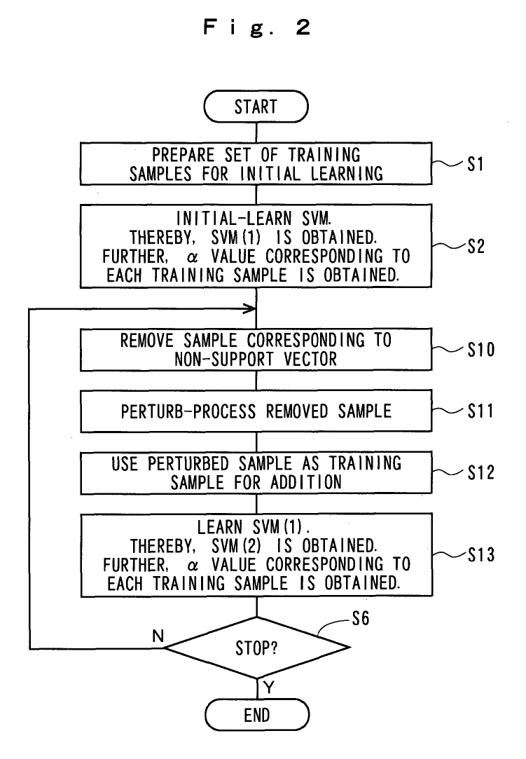

Subsequently, a second embodiment of the present invention will be described with reference to FIG. 2. In the first embodiment which the new samples obtained by the perturbation are all added to a set of original samples so as tore-learn, the number of samples after the addition becomes enormous, and thus, the learning, i.e., an optimization calculation on the boundary surface becomes difficult in terms of a calculation amount. To solve this difficulty, in the second embodiment, the new samples to be added are selected. It is noted that, to select the new sample, a well-known software margin for performing linear separation allowing some classification errors is used.

Steps S1 and S2 in FIG. 2 are the same as those in FIG. 1, and as such, description will be omitted. At step S10, samples corresponding to non-support vectors are removed. This process can be carried out based on support vector information obtained in the process at step S2, i.e., the parameter (α value). This will be described in detail later. At step S11, a perturbation process is performed on the removed samples, and the perturbed samples are re-learned as the training samples for addition. It is noted that the removal of the samples corresponding to the non-support vectors will be described in detail later.

The non-support vector samples are apart from the classification boundary surface, and thus, even when the samples are subjected to perturbation, it is highly likely not to affect the position of the boundary surface. Therefore, according to this embodiment, when the non-support vectors are not subject to perturbation, it becomes possible to achieve the accuracy improvement and the reduction in the calculation amount.

Subsequently, a third embodiment of the present invention will be described with reference to FIG. 3. In this embodiment, when the outlier is wrongly labeled under the realistic situation that an outlier (deviated value) exists in a set of training samples for initial learning, it is highly likely the perturbation for the outlier adversely affects the re-learning of the SVM. Therefore, since there are also merits in the calculation amount, a target to be perturbed is further limited to support vectors existing on a margin hyperplane (non-bounded support vectors).

Steps S1 and S2 in FIG. 3 are the same as those in FIG. 1, and as such, description will be omitted. The support vector information at step S2 is obtained by initially learning data for initial learning of a known class label. The support vector information has a misclassification probability of a few percent, for example 2% (=0.02), as described later. Therefore, at step S21, in order that the data wrongly attached with labels is not used for re-learning, the target to be perturbed is set to a sample corresponding to the support vector existing on the soft margin hyperplane. At step S22, the selected sample is subjected to a perturbation process. The processes at the steps S21 and S22 will be described in detail later. At step S12, the perturbation-processed sample is set as the training sample for addition, and at step S13, the training sample for initial learning and the training sample for addition are used to re-learn and generate an SVM (2).

In the present embodiment, because the label imparting of the training sample to be newly added is precise, the effect of the re-learning is increased unlike in the semi-supervised learning in the conventional technology and the first and second embodiments.

The third embodiment will be more specifically described below. In the following description, detection of a shot boundary in a video instantaneous cut will be described as an example. However, the present invention is not limited thereto. The present invention can also be applied to detection of various shot boundaries such as “fade out” in which a current shot is transitioned to a next shot while a screen gradually darkens or “dissolves” in which videos are gradually switched while being overlapped. Moreover, the present invention can also be applied not just to the detection of shot boundary of videos but also to classification or identification of other objects.

In the normal SVM, a soft margin for performing linear separation allowing some classification errors is used.

Obviously, the data for shot boundary detection cannot also be linearly separated on the kernel space; therefore, learning is performed by using the SVM by the soft margin. A hyperparameter value for this soft margin is represented by C. A classification function Φ(x) is written as follows:

$$Φ ( x ) = sign ( {\sum }_{i = 1}^{N} {α}_{i} {y}_{i} k ( {X}_{i} , X ) + b ) \qquad [ Equation 1 ]$$

However, 0≦αᵢ≦C.

In the Equation 1, xᵢ represents the sample data for learning, x represents the sample, yᵢ(=+1 or −1) represents the class label, and αᵢ represents the internal parameter, representing a Lagrange multiplier, for example. In the present embodiment, a sample of y=−1 is a shot boundary and when y=+1, it is not a shot boundary. k(xᵢ, xⱼ) represents a kernel function, and in a case of Gaussian kernel, it is k(xᵢ, xⱼ)=exp{−γ·∥xᵢ−xⱼ∥}.

A sample corresponding to 0<αᵢ is called a support vector. In particular, a support vector of 0<αᵢ<C exists on margin hyperplanes H1 and H2.

If the distribution of class estimation results obtained by using the learned SVM is approximated with a logistic function, the classification performance often improves. Actually, in the shot boundary detection, using the logistic function further improves the accuracy.

$$f ( x ) = {\sum }_{i = 1}^{N} {α}_{i} {y}_{i} k ( {X}_{i} , X ) + b \qquad [ Equation 2 ]$$

With this, a logistic function P representing a conditional probability of each class is represented by the following equation:

$$P ( y = - 1 \vert x ) = \frac{1}{1 + exp ( Af ( x ) + B )} \\ P ( y = + 1 \vert x ) = \frac{exp ( Af ( x ) + B )}{1 + exp ( Af ( x ) + B )} \qquad [ Equation 3 ]$$

A and B are calculated by using maximum likelihood estimation from the sample data for training.

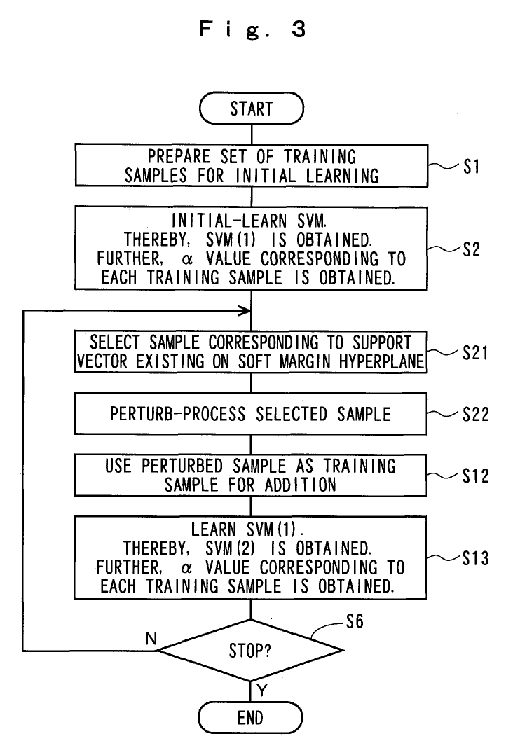

FIG. 4 is a graph for the logistic function of SVM constructed from the training data for actual cut detection (=partial problem of shot boundary detection). The horizontal axis represents f(x) and the vertical axis represents the probability. In a sample x existing on the soft margin hyperplane of “class (y=−1) of a shot boundary instance”, a relationship of f(x)=−1 is established. Therefore, in the sample x, P(y=+1|x)=0.02, P(y=−1|x)=0.98, and P(y=−1|x)>P(y=+1|x). As such, the class of x is determined to be “class of a shot boundary instance.” However, the misclassification probability is 0.02, and thus, it is not so low. It is noted that the graph of the logistic function moves parallel in the right-left direction depending on the value of B/A.

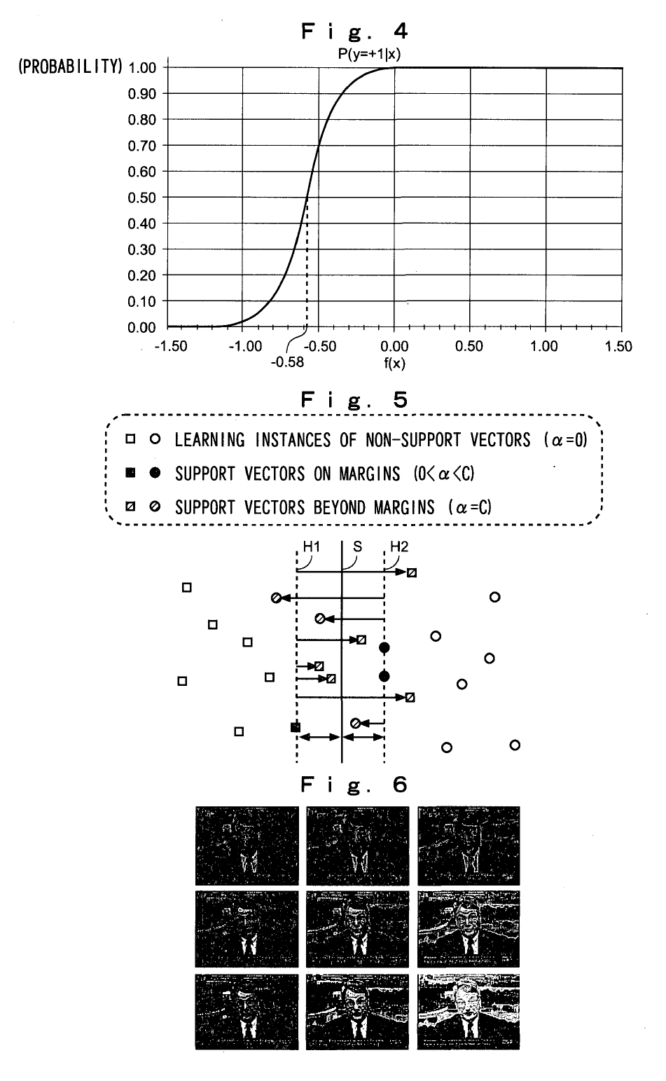

When the SVM learning is executed once (the step S2), a value of a parameter αᵢ corresponding to each training sample i is obtained. On principle, a non-support vector (where α₁=0 is established) does not affect the position of the classification boundary surface. As shown in FIG. 5, the non-support vectors □ and ◯ are located relatively apart from a boundary surface S. Even when the new samples are generated by perturbing these samples, they are a distance from the existing boundary surface. Therefore, even if the new samples are added for learning, it is highly likely that as non-support vectors, the new samples do not affect the position of the boundary surface S. Consequently, it is more preferable that the non-support vectors are not subject to perturbation. With respect to a proportion in number between support vectors and non-support vectors, normally, the proportion of non-support vectors is larger. Thus, when the target to be perturbed is limited to the support vector, the effect of the reduction in the calculation amount is also increased.

It is highly likely that a support vector (where αᵢ=C is established) being near the classification boundary is an outlier. It is difficult to automatically determine whether the outlier is caused due to either a mislabel or uncommon noise. There is a higher risk if the support vector (where αᵢ=C is established) is added as a new sample, and as such, the target to be perturbed is limited to support vectors ▪ and existing on a margin hyperplanes (where 0<αᵢ<C is established) (non-bounded support vectors). This process is equivalent to the step S21.

Subsequently, a generation process of samples attached with labels by perturbation (the step S22) will be described.

As an example of perturbation, an image quality conversion of a video is considered. In the image quality conversion, there are cases where the luminance is collectively increased or decreased (brightness conversion) or the contrast is strengthened or weakened (contrast conversion). The luminance conversion equation in each case is given below.

In a case of brightness conversion

Z′=256.0×[Z÷256.0]^{δ}

Z: Input luminance information (0 to 255)

Z′: Output luminance information (0 to 255)

δ: Brightness conversion adjustable parameter

In a case of contrast conversion

Z′=256.0+(1.0+exp(−η×(Z−128.0)))

Z: Input luminance information (0 to 255)

Z′: Output luminance information (0 to 255)

η: Contrast conversion adjustable parameter

FIG. 6 shows an example of an image quality conversion used this time. An image at the center is an image on a soft margin hyperplane. Images on the top row have a low contrast. Images on the bottom row have a high contrast. Moreover, images in the right column have high brightness, whereas those in the left column have low brightness.

It is noted that besides the brightness conversion and contrast conversion, other perturbations such as blurring conversion, edge enhancement, etc., may also be used.

In the perturbation learning of the present invention, the fact that the position of the shot boundary does not change, even if the image process such as luminance conversion is performed on the video data, is utilized to generate the training sample having a new feature amount. Unless there is an error in imparting the class label in the data for initial learning (original), the imparting of the class label of the training sample to be newly added is precise, which is greatly different from the normal semi-supervised learning.

Subsequently, a fourth embodiment of the present invention will be described. In the shot boundary detection problem which is a subject in the present embodiment, the number of shot boundary instances is significantly fewer as compared to that of non-shot boundary instances. Therefore, when a conditional probability indicated by the logistic function obtained by sigmoid training is evaluated, in the support vectors existing on the margin hyperplane on a side of “class of non-shot boundary instances,” the probability of “class of shot boundary instances” is almost zero. On the contrary, in the support vectors existing on the margin hyperplane of “class of shot boundary instances,” the probability of “class of non-shot boundary instances” is somewhat high. As a result, in the present embodiment, the target to be perturbed is limited to support vectors on a margin hyperplane, in which a conditional probability of other classes is equal to or more than a certain threshold value.

As mentioned above, in the shot boundary detection problem which is a subject in the present embodiment, since the number of shot boundary instances is significantly fewer as compared to that of the non-shot boundary instances, the determined position in the logistic function in FIG. 4 is f(x)=−0.58 and enters into the left side (y=−1, i.e., the side of the shot boundary class). As mentioned above, even in the sample existing on the soft margin hyperplane with f(x)=−1, the conditional probability of “non-shot boundary class” does not become zero. This indicates that two classes are mixed near the hyperplane on the kernel space. On the contrary, in f(x)=+1, which represents the soft margin hyperplane of a non-shot boundary class, the conditional probability of a non-shot boundary class is almost 1.0, and therefore, the vicinity of hyperplane is configured only by the non-shot boundary class instances. In support vectors on a hyperplane (where f(x)=−1 is established), the reliability of the imparted labels is also high, and the separation from the other classes in the vicinity (=non-shot boundary classes) is not very good. Thus, these vectors are located in a position suitable for adding a new sample in the vicinity. Therefore, when there is a bias in the number of samples among classes such as shot boundary detection, the conditional probability that the support vectors on the soft margin hyperplane belong to other classes is evaluated by the logistic function derived by using a maximum likelihood estimation, and only a support vector on a hyperplane having an inferior determination performance may be subject to perturbation.

Thus, according to each of the above mentioned embodiments, the accuracy improvement of the SVM and reduction in the calculation amount can be achieved. Further, the present invention is not limited to each of the above-described embodiments, and it is obvious that various modifications that fall within the scope of the present invention are included.

1. A re-learning method for a support vector machine, comprising:
a step of learning an SVM by using a set of training samples for initial learning which have known labels;
a step of perturbation-processing the training samples for initial learning;
a step of using the perturbation-processed sample as a training sample for addition; and
a step of re-learning the learned SVM by using the training sample for initial learning and the training sample for addition.

2. A re-learning method for a support vector machine according to claim 1, wherein
the training sample for initial learning to be perturbation-processed is a training sample obtained by removing the training sample for initial learning corresponding to a non-support vector.

3. A re-learning method for a support vector machine according to claim 1, wherein
the training sample for initial learning to be perturbation-processed is a training sample corresponding to a support vector existing on a soft margin hyperplane.

4. A re-learning method for a support vector machine according to claim 3, wherein
the training sample for initial learning to be perturbation-processed is a training sample corresponding to a support vector existing on a soft margin hyperplace having an inferior determination performance at the time of evaluating a conditional probability that a support vector on the soft margin hyperplane belongs to another class using a logistic function derived by using a maximum likelihood estimation.

5. A re-learning method for a support vector machine according to claim 1, wherein
the re-learning method for a support vector machine is used for a shot boundary detection of an image process.

6. A re-learning method for a support vector machine according to claim 2, wherein
the re-learning method for a support vector machine is used for a shot boundary detection of an image process.

7. A re-learning method for a support vector machine according to claim 3, wherein
the re-learning method for a support vector machine is used for a shot boundary detection of an image process.

8. A re-learning method for a support vector machine according to claim 4, wherein
the re-learning method for a support vector machine is used for a shot boundary detection of an image process.

9. A re-learning method for a support vector machine according to claim 5, wherein
the perturbation process includes a brightness conversion, a contrast conversion, a blurring conversion, or an edge enhancement of video.

10. A re-learning method for a support vector machine according to claim 6, wherein
the perturbation process includes a brightness conversion, a contrast conversion, a blurring conversion, or an edge enhancement of video.

11. A re-learning method for a support vector machine according to claim 7, wherein
the perturbation process includes a brightness conversion, a contrast conversion, a blurring conversion, or an edge enhancement of video.

12. A re-learning method for a support vector machine according to claim 8, wherein
the perturbation process includes a brightness conversion, a contrast conversion, a blurring conversion, or an edge enhancement of video.
